(19) United States
(12) Patent Application Publication
(10) Pub. No.: US 2016/0050037 A1
(43) Pub. Date: Feb. 18, 2016

(54) EMERGENCY ALERT NOTIFICATION DEVICE, SYSTEM, AND METHOD

(71) Applicant: VALCOM, INC., Roanoke, VA (US)

(72) Inventor: Stacy Eugene Webb, Roanoke, VA (US)

(73) Assignee: VALCOM, INC., Roanoke, VA (US)

(21) Appl. No.: 14/823,651

(22) Filed: Aug. 11, 2015

Related U.S. Application Data
(60) Provisional application No. 62/036,318, filed on Aug. 12, 2014.

(51) Int. Cl. H04H 20/59; H04B 5/00; H04H 20/71

(52) U.S. Cl. CPC H04H 20/59; H04H 20/71; H04B 5/0025

(57) ABSTRACT

A device, system, and method for determining a user's proximity within a predefined radius. A mobile electronic device with location software thereon can record and analyze ambient noise to determine after initiated the user's estimated locations as well as to track the user's movements throughout a predefined radius. The mobile locate software may present information to the user according to the user's position within the radius of the area. The type and nature of the information presented to the user can be changed according to the user's distance from emergency services as well as how quickly the user is approaches the safe zones. The software may provide detailed data about the movement of the user and additional users of the software that are within the determined radius. This information may be correlated with local, state and federal officials in the determination of the initial incident.

### FIELD

An emergency alert notification device, system, and method for locating and adaptively communicating with a user, for example, based on the proximity of the user relative to an incident or event and the location of one or more safety zones.

The emergency alert notification device, method, and system are in the technical field of direct to mobile notifications. More particularly, in the technical field of notification of the existence of an emergency situation to mobile and non-mobile communication devices.

Further, the emergency alert notification device, method, and system are in the technical field of mobile to mobile and server to client alert. In addition, the emergency alert notification device, method, and system relate to a personal safety device, system, and method for determining user proximity to one or more safety zones as well as adaptive communication with the user.

### BACKGROUND

A significant safety issue within our society is the speed at which law enforcement and those determined to provide protection to an area arrive at the affected location or scene. Additionally, the personal safety is often viewed as the sole responsibility of the individual. Accordingly, what is needed is a device, system, and method for improving the time span between when an incident occurs and the arrival of emergency personnel (i.e. decreasing response time). There is a need for a system that reduces the overall response time involved to determine a victim's current location, and the location at which the initial incident occurred.

With the advent of mobile communications, no method or process exists in regards to ability to communicate to devices regardless of the OS (operating system) the drives of the devices. There is no universal way or protocol for users of these devices to receive notification based on their present location.

Further, there is no way to send an emergency alert notification to an individual within a computed radial distance from a situation that requires attention.

Many lives have been lost due to an individual entering into an area that could be considered dangerous due to an emergency situation including, but not limited to, fire, tornado, dangerous individual(s) nearby, school shooter, threats of violence, or person in need of help nearby. Emergency personnel have struggled with the inability to identify and notify individual(s) that may have either been involved or been in proximity to an event or scene that requires evacuation and/or assistance.

### SUMMARY

An emergency notification device, method, and system.

An emergency notification device, method, and system for alerting a person or user.

An emergency notification device, method, and system for alerting a person or user of a threat.

An emergency notification device, method, and system for allowing a person or user to initiate a call for help to one or more points.

An emergency notification device, method, and system for automatically performing various actions based on data from one or more 911 calls.

An emergency notification device, method, and system for alerting a user within proximity of the location of an initial alert.

An emergency notification device, method, and system for alerting and communicating with a user within proximity of the location of an initial alert.

An emergency notification device, method, and system for alerting a user within proximity of the location of an initial alert, and communicating information to the user.

An emergency notification device, method, and system for alerting a user within proximity of the location of an initial alert, and instructing the user.

An emergency notification device, method, and system for alerting a user within proximity of the location of an initial alert, and instructing the user to avoid personal harm.

An emergency notification device, method, and system for alerting a user within proximity of the location of an initial alert, and instructing the user with directions to one or more safety zones.

An emergency notification device, method, and system for alerting and communicating with a user within proximity of the location of an initial alert, and tracking the movement of the user.

An emergency notification device, method, and system for alerting a user located within a zone containing the location of an initial alert.

An emergency notification device, method, and system for alerting a user located within proximity of a radius distance of the location of an initial alert.

An emergency notification device for alerting a user within proximity of the location of an initial alert comprising or consisting of a transmitter for generating one or more alert notifications.

An emergency notification device for alerting a user within proximity of the location of an initial alert comprising or consisting of a transmitter for generating one or more alert notifications, and a tracker for tracking the user.

An emergency notification device for alerting a user within proximity of the location of an initial alert comprising or consisting of a transmitter for generating one or more alert notifications, and a tracker for tracking one or more mobile devices within proximity of the location of the initial alert.

An emergency notification device for alerting a user within proximity of the location of an initial alert comprising or consisting of a transmitter for generating one or more alert notifications, and a tracker for single to multiple mobile and stationary devices.

An emergency notification device for alerting a user within proximity of the location of an initial alert comprising or consisting of a transmitter for generating one or more alert notifications, and a tracker of single to multiple mobile and stationary devices based on a distance or radial distance proximity to an initial alert location.

An emergency notification method or system for alerting a user within proximity of the location of an initial alert comprising or consisting of generating one or more alert notifications; and transmitting the one or more alert notifications to a user.

An emergency notification method or system for alerting a user within proximity of the location of an initial alert comprising or consisting of generating one or more alert notifications; transmitting the one or more alert notifications to a user; and tracking the user.

An emergency notification method or system for alerting a user within proximity of the location of an initial alert comprising or consisting of generating one or more alert notifications; transmitting the one or more alert notifications to a user; and tracking one or more mobile devices within the proximity of the location of the initial alert.

An emergency notification method or system for alerting a user within proximity of the location of an initial alert comprising or consisting of generating one or more alert notifications; transmitting the one or more alert notifications to a user; and communicating the direction or location of one or more safety zones to the user.

An emergency notification method or system for alerting a user within proximity of the location of an initial alert comprising or consisting of generating one or more alert notifications; transmitting the one or more alert notifications to a user; communicating the location of one or more safety zones to the user; and tracking one or more mobile devices within the proximity of the location of the initial alert.

An emergency notification device, method, and system, for example, a personal safety device, method, and system using one or more mobile devices.

An emergency notification device, method, and system for alerting a person or user comprising or consisting of an alert initiation device, step, or procedure.

The device, system, and method are being developed in response to the present state of the art and, in particular, in response to the problems and needs in the art that have not yet been solved by currently available devices, methods, and systems. Accordingly, the device, system, and method are being developed for facilitating the speed at which emergency responders can locate a victim and determine an origin of incident.

The device, system, and method have been developed to provide a checkout process where a user may use software (which may include personal alert software to facilitate the sending of an alert including but not limited to direct connection, SMS, mms, Text, Voice, audible and physical, herein referred to generally as personal alert software) on a mobile electronic device such as a tablet computer or a mobile telephone. The personal alert software may interact with the user during the alert initiation process.

For example, the personal alert process can involve the user's mobile electronic device, such as a smart phone (e.g. iPhone, Android) or tablet. The personal alert software may interact with other electronic devices to determine the user's proximity to a safe zone. Upon interaction with external devices, the personal alert software may then interact with the user and allow the user to begin the alerting process.

For example, a machine-readable code can be used to interact between the user's mobile electronic device and the personal alert system. The machine-readable code may comprise a conventional barcode or a two-dimensional barcode (e.g., a Quick Response (QR) Code). The data encoded within a machine-readable code may vary between different embodiments and different purposes or goals of the embodiment. In selected embodiments, a machine-readable code may encode a transaction identification (ID) uniquely identifying a particular information set. Alternatively, or in addition thereto, a machine-readable code may encode data regarding the alert software and/or its location therein.

For example, sound can be used to interact between the user's or individual's mobile electronic device and the personal alert software. The mobile electronic device may detect sound from the user's or individual environment and from other devices located within the predetermined radius. The detected sound can be processed to determine the user's or individual's location within an area and, more particularly, the user's or individual's proximity to a predetermined safe-zone.

For example, personal alert software on the user's mobile electronic device can change functionality or modify how it interacts with the user or individual based on the user's or individual's proximity to predetermined locations and predetermined safe zones. The personal alert software can provide different information to the user or individual, and can initiate different steps of the personal alert process based on proximity to a predetermined safe zone (area).

For example, the user can configure the personal alert software on the user's mobile electronic device to ignore notifications and alerts from other devices and/or from the server for a period of time (e.g. calendar-based do not disturb).

For example, the user can configure the personal alert software on the user's mobile electronic device to receive notifications and alerts designated for particular groups of devices.

### Emergency Alert Notification

The emergency alert notification device, method, and system can alert one or more users located within proximity of an incident or scene. For example, an incident occurs at point C and a first user (e.g. victim) involved in the incident located at point A makes the initial alert, for example, using his or her mobile device. Alternatively, another or second user within proximity of point C (e.g. within viewing distance) can provide the initial alert as to the existence of the incident involving the first user (e.g. victim).

After the initial alert, all or some of the users located within proximity of the incident can be alerted, for example, by their mobile devices. The proximity, for example, can be a distance from the location of the initial alert, a radial distance from the location of the initial alert, a zone containing the initial alert, or a zone within a distance from the location of the initial alert. A protocol can be developed when to alert or not alert a particular user or users within proximity. For example, a user (e.g. most likely the aggressor) in closest proximity to the first user (e.g. victim) can be blocked from being alerted, or alerted in a manner different from the other users in proximity to the incident to likely cause the aggressor to flee the incident (e.g. loud alarm or siren signal, electronic voice instructing aggressor in a manner to deter ongoing actions or involvement such as an alert “police are on the way” or indicating “scene is now being recorded by audio and/or video”, or “we know your identity and your name is . . . ”).

### Device

The emergency alert notification device can be a personal electronic device such as a mobile device (e.g. cell phone, smart phone, tablet, notebook, computer watch). The emergency alert notification device can be configured as purchased to operate with the emergency alert notification system, and/or an application can downloaded to the device to operate with the emergency alert notification system.

### System

The emergency notification system comprises or consists of one or more electronic devices capable of audio, visual, tactile feedback, or any combination thereof and a local area network (LAN) comprising a server. For example, the one or more electronic devices can be a personal electronic device or mobile electronic device or personal computing device such as a smart phone, iPhone, Android phone, pad, iPad, iWatch, computer watch, or otherwise a portable electronic device that can be carry by or on a user.

The emergency notification system can comprise or consist of a proximity locating device, method, and system for locating a user. For example, a device, method, and system for determining a user's proximity within a predefined radius. A mobile electronic device with location software thereon can record and analyze ambient noise to determine after initiated the user's estimated locations and tracking the user's movement throughout a predefined radius. The mobile locate software can present information to the user according to the user's position within the radius of the area. The type and nature of the information presented to the user can be changed according to the user's distance from emergency services as well as how quickly the user approaches one or more safe zones. The software can provide detailed data about the movement of the user and additional users of the software that are within the determined radius. This information can be correlated with local, state, and federal officials in the determination of the initial incident.

### Method

The emergency notification method can comprise or consist of one or more of the following steps:
1) initiating alert signal by an individual or user at or in proximity of an incident or scene (e.g. pressing button, touching screen, voice command, switch or sensor on mobile device (e.g. mobile device accelerometer sensing thrown mobile device impact ground or object);
2) communicating the initiating alert to a local area network (LAN) comprising a server;
3) generating personal alert for one or more selected users in proximity of location of incident; and
4) communicating information or instructions to users alerted (e.g. location or directions to one or more safety zones or locations).

The emergency alert notification method can comprise or consist of transmitting an alert notification. Further, the emergency alert notification method can comprise or consist of transmitting an alert notification in combination with location tracking of single to multiple mobile and stationary devices based on radial distance proximity to an initial alert location.

### Alert Initiation

The alert can be activated in conjunction with the application and server user interface. For example, the alert can be activated manually by 1) a user or person pressing an icon/link/button within the mobile application using a mobile device; 2) a user or person using a gesture such as a swipe within the mobile application using a mobile device; 3) a user or person pressing an icon/link/button from a Web Brower (Web App Version) using the mobile device; 4) initiating via the Main Server Control UI (User Interface); 5) a user or person conducting a long press/hold of the mobile device physical button(s) such as i) Home button, ii) Volume Up button, iii) Volume Down button, and/or iv) combination of multiple buttons; and 6) the physical movement of the mobile device such as i) shaking the mobile device, ii) drastic change in elevation of the mobile device (e.g. dropping device, rapidly lifting device), and iii) combination of physical gestures (e.g. moving device left to right and then shaking mobile device).

Alternatively, or in addition, for example, the alert can be activated automatically by 1) the physical movement described above regarding the manual activation; 2) an alert or alerts being initiated within a predetermined radius (e.g. within a predetermined radius of the incident or event); 3) an alert or alerts being initiated from, for example, i) Emergency Tower, ii) Call Box, iii) Pedestal, and iv) Other altering devices or apparatus; 4) Audio Detection, for example, of i) Gunshot, ii) Glass Breaking, iii) Vocal Inflection (e.g. Drastic alteration in pitch or tone), iv) Screaming, v) Whistling, vi) Other predetermined sound parameter(s); 5) Proximity to potential threat (e.g. user or person), for example, initiated from main User Interface (UI); 6) Proximity to man-made threat, for example, i) initiated from CAP message, and ii) initiated from Server User Interface (UI); 7) Proximity to other user(s) or person(s); 8) entering or leaving a predetermined area radius, for example, Geo-Fence; 9) being Time-Based, for example, user or person in geo-fenced area in excess of allowed time; 10) being in Restricted Area; 11) being in Proximity to BLE (Bluetooth Low Energy) Device(s); and 12) a Third Party Application, for example, via ValcomLocate API using, for example, i) eLaunch, and/or ii) BlackBoard.

Any variations or combinations of the above alert initiations can be used to initiate alerts to end users or persons. The actual values (e.g. distances, ranges, and time of the day) can be set and/or customized per location(s).

### BRIEF DESCRIPTION OF THE DRAWINGS

FIG. 1 is a schematic block diagrammatic view of an ambient noise determination system.

FIG. 2 is a schematic block diagrammatic view of a multiple ambient noise determination system in the context of an enterprise-wide system.

FIG. 3 is a flow chart diagrammatic view of the operation of the emergency alert.

FIG. 4 is a graphic view illustrating a method for verifying the location of a mobile electronic device.

FIG. 5 is a diagrammatic view illustrating a personal alert being initiated, and actively tracking devices within a core radius.

FIG. 6 is a diagrammatic view illustrating passively tracking devices within a secondary radius alerted.

FIG. 7 is a diagrammatic view illustrating radial proximity movement in relation to a device that initiated an original personal alert.

FIG. 8 is a flow chart diagrammatic view illustrating an emergency notification alert method and system.

FIG. 9 is a flow chart diagrammatic view for determination of proximity of devices to a device initiated alert.

FIG. 10 is a flow chart diagrammatic view of a process of determination for alert recipients.

### DETAILED DESCRIPTION

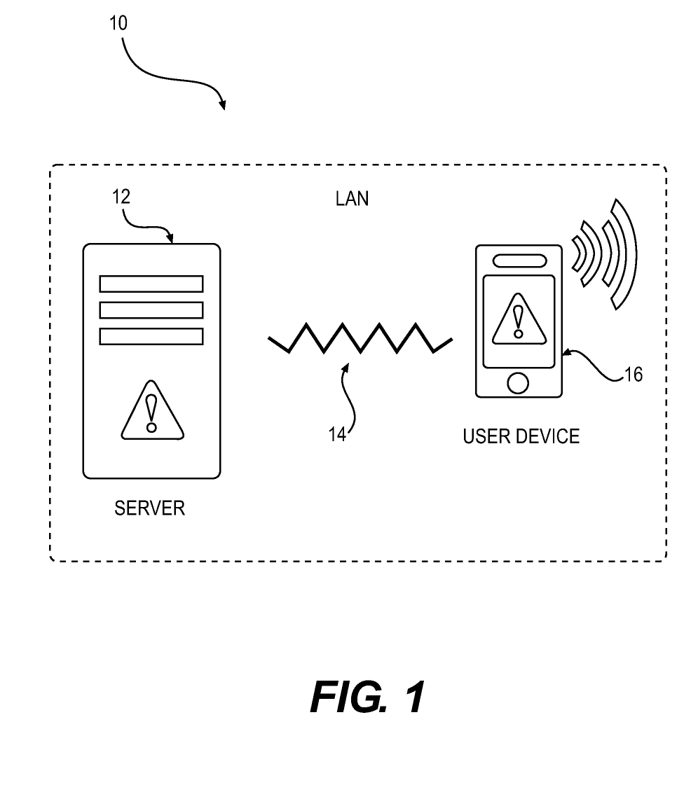

An Emergency alert notification system 10 is illustrated in FIG. 1. The emergency alert notification system 10 comprises or consists of a Server 12, a Local Area Network (LAN) 14, and a User Device 16. In the arrangement, for example, the Server 12 and User Device 16 can wirelessly communicate with each other through the Local Area Network (LAN) 14.

The User Device 16 can comprise a control (e.g. button, slide, control device on Graphic User Interface (GUI)) to allow the user to activate an alert. Alternatively, the User Device can be configured (e.g. using a software application) to initiate an alert in other manners. For example, the User Device 16 can initiate an alert when thrown by the user and impacting the ground, wall, a person (e.g. assailant), or object (e.g. car, desk, cabinet) utilizing the accelerometer of the User Device 16, a special voice command (e.g. high pitch scream and/or yell for “HELP”), specific series of taps on User Device 16 by the user, blowing into orifice in device (e.g. causing an internal fan motor to spin and create control signal for alert and making audio alert like a whistle).

The alert from the User Device 16 can be transmitted or communicated in various manners. All types of communications for phone to phone, to server, for location, fine tune location can be used. For example, the alert can be a wireless signal communicated via a Local Area Network (LAN), cellular network and/or radio transmission. The User Device 16 can also be configured to make an audio warning (e.g. noise, siren, voice) upon initiating the alert to alert others within hearing distance of the User Device 16 of an incident or event. For example, the audio warning can only be shut off by the user using his or her access code.

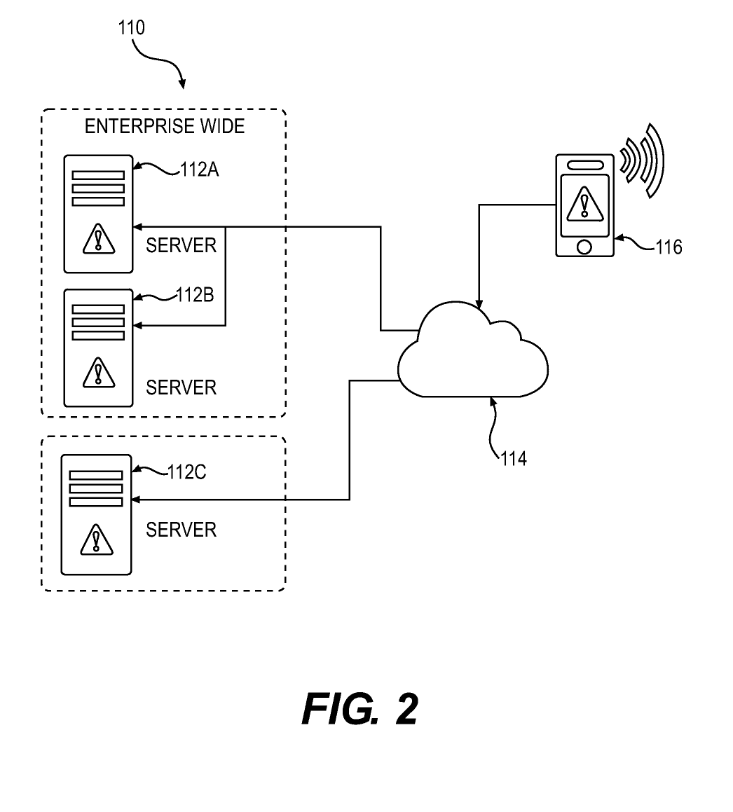

Another Emergency alert notification system 110 is illustrated in FIG. 2. The Emergency alert notification system 110 comprises Server 112A, Server 112B, independent Server 112C, Cloud 114, and User Device 116. The Server 112A and Server 112B operate in conjunction using Enterprise Wide software. The Server 112A, Server 112B, independent Server 112C, and User Device 116 can wirelessly communicate with each other through the Cloud 14.

The Emergency alert notification systems 10 and 110 can be used independently, or in conjunction together.

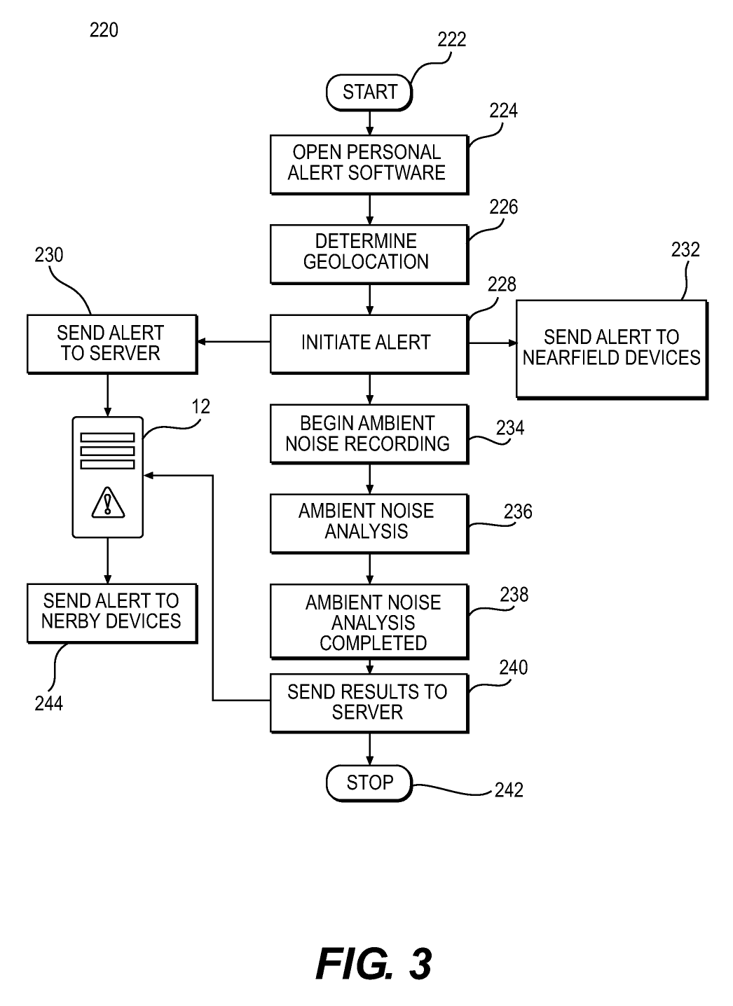

The operation of the of the emergency alert notification system 10 and/or 110 is illustrated in the operational flow chart 220 shown in FIG. 3.

The operation begins with the sequence Start (Step 222), Open Personal Alert Software (Step 224), Determine GeoLocation (Step 226), and then Initiate Alert (Step 228).

After the Initiate Alert (Step 228), simultaneously the Send Alert to Server (Step 230), Send Alert to NearField Devices (Step 232), and Begin Ambient Noise Recording (Step 234) occur. The Begin Ambient Noise Recording (Step 234) proceeds is a sequence to Ambient Noise Analysis (Step 236), Ambient Noise Analysis Completed (Step 238), Send Results to Server (Step 240), and then Stop (Step 242).

After the Server 12 receives the Results from Send Results to Server (Step 240), then the Server 12 proceeds to Send Alert to Nearby Device (Step 244).

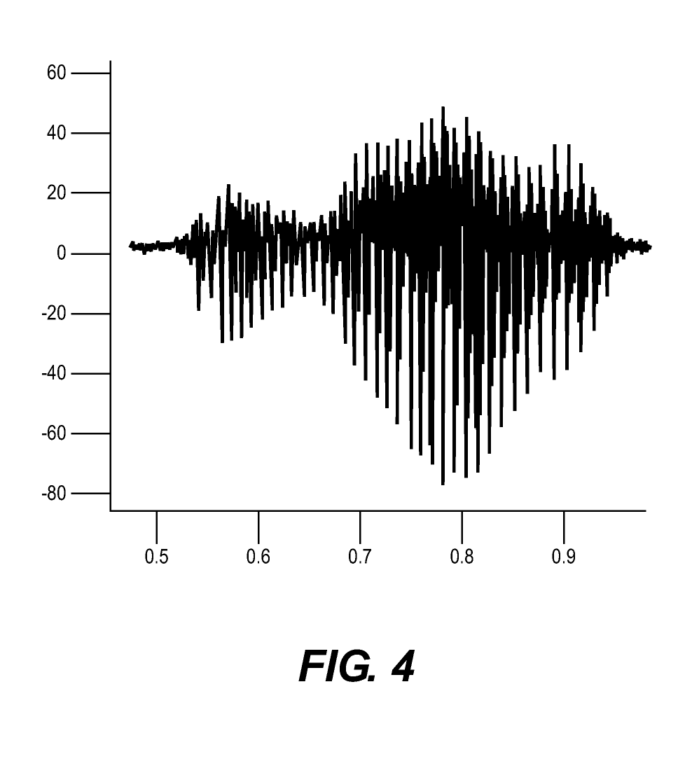

The graph shown in FIG. 4 illustrates the method for verifying the location of other electronic devices (e.g. mobile telephones) relative to a first electronic device initiating the alert. The graph sets the location of the first electronic device at 0.0 and the location of the other electronic devices by fractions (or percentages) of the selected core radius CR (x-axis) verses the signal strength (y-axis). The graph illustrates three (3) other electronic devices located around 0.58CR, 0.78CR, and 0.89CR.

The device location can be determined by a number of methods. For example, the following methods can be used:
1) Device's internal GPS (Global Positioning System, a space-based satellite navigation system that provides location and time information in all weather conditions, anywhere on or near the Earth where there is an unobstructed line of sight to four or more GPS satellites).
2) BLE (Bluetooth Low Energy proximity sensing which can transmit the UUID which is picked up by nearby device or server and is turned into a physical location).
3) Wi-Fi LAN Connection (this is done by determining the signal strength between the device and the nearest Wi-Fi router that it is connected to). This is unique to the disclosed device, system, and method, and not a standard protocol.

The user ID can be determined based on the device UUID (universally unique identifier). The UUID is an identifier standard used in software construction, standardized by the Open Software Foundation (OSF) as part of the Distributed Computing Environment (DCE). Multiple devices can be linked to a single user based on username and password (both determined by the end user).

To determine who else or what other devices are in the vicinity, this is determined as follows:
1) Devices “check-in” to server with geo-location (latitude and longitude) at pre-determined time intervals. This information is not saved on the server until an alert has been initiated and only if that device has either initiated the alert or is within a pre-determined radius of a device initiating an alert. Information is then relayed to all devices within the pre-determined radius.
2) Using NFC (Near field communication, a set of standards for smartphones and similar devices to establish radio communication when they are within proximity on one another). NFC standards cover communications protocols and data exchange formats, and are based on existing radio-frequency identification (RFID) standards including ISO/IEC 14443.

The data passed between the phone and server during the alert is as follows. After installation of the application, the only information that is passed at regular intervals between the device and server is the UUID and Geo-Location. Once an alert is initiated additional information is sent to the server including but not limited to UUID, Geo-Location, Time stamp, Device Information. Information passed to devices, which have not initiated the alert, but are within the pre-determined radius, includes only that an alert has been initiated and the geo-location information of the initiating device. Alerts that originate from the server are one-way only. These alerts may include text, images, video, and/or audio. Alert information may include but is not limited to Custom and CAP (Common Alerting Protocol, an XML-based data format for exchanging public warnings and emergencies between alerting technologies) messages.

Alert information is sent in JSON (JavaScript Object Notation, is an open standard format that uses human-readable text to transmit data objects consisting of attribute-value pairs. It is used primarily to transmit data between a server and web application.). This is done using TCP/IP and/or Bluetooth (when enabled and within proximity).

When an alert is received from a device, the server performs several parallel actions.
1) The server begins to “actively track” the device. This means device information is saved and displayed on the server side UI (user interface). Any device that is within the pre-determined “urgent proximity zone” are also actively tracked. These remain active for the duration of the alert.
2) Devices within the pre-determined “alert proximity zone” are then notified, using protocols above, that there is a user in-need of assistance. These devices may be displayed though the server UI for the duration of the alert, however they are not “actively tracked”.
3) Notification of an alert (including device information) is relayed to required authorities via pre-determined means (this can include but is not limited to email, SMS, direct push, voice and/or video connection).
4) A direct voice/video connection is also available via both the server UI and the direct send to the administrative users.

To determine who or which device initiated an alert (e.g. by pressing the alert button), the UUID from the particular device is used to determine the User ID.

### System

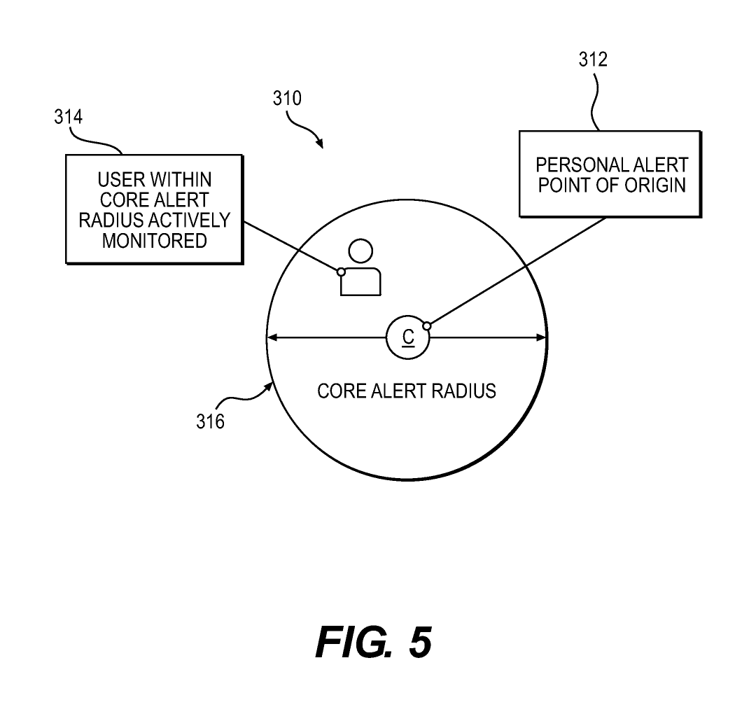

The environment 310 around the incident or event involving the emergency alert communication system is illustrated in FIGS. 5 thru 7.

As illustrated in FIG. 5, a first user 312 is located at the center C of the environment 310 and a second user 314 is in proximity relative to the first user 312 within the environment 310.

The first user 312 initiates a personal alert from his or her personal electronic device. Based on the latitude and longitude for the personal electronic device of the first user 312, which is determined when the personal alert is initiated, a core alert radius 316 is determined and users (e.g. first user 312 and second user 314) are tracked when moving within the core alert radius 316. The personal electronic devices of all users (e.g. first user 312 and second user 314) that reside within the core alert radius 316 are continuously monitored regardless of proximity to the initiating or alerting personal electronic device, until manually deactivated.

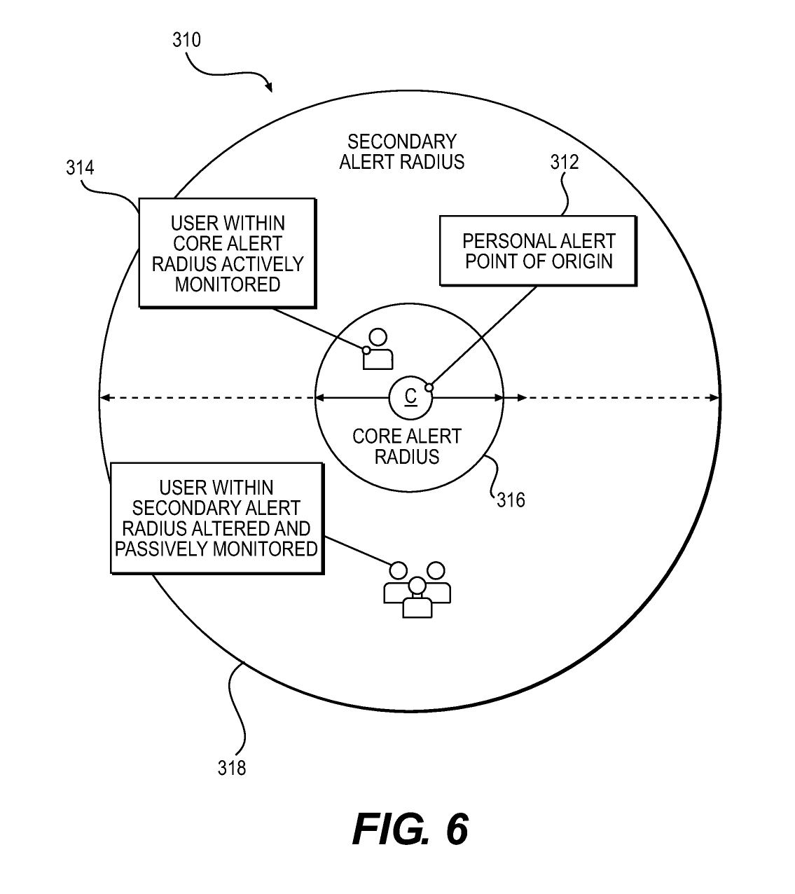

As illustrated in FIG. 6, a secondary alert radius 318 is determined in addition to the core alert radius 316. The personal electronic devices of the first user 312, second user 314, and additional users 320 located within the secondary alert radius 318 are alerted to the location of the initiating or alerting personal electronic device and their proximity to that location.

The personal electronic devices located within the secondary radius are passively tracked. Specifically, while the initial alert is active and the personal electronic devices remain within the secondary alert radius 318, the information from these person devices is relayed to another system (e.g. tracking system) to be displayed in real-time.

Once a personal electronic device that existed within the original secondary alert radius 318 leaves that secondary alert radius, that particular personal electronic device is no longer relaying movement location to the other system (e.g. tracking system). If a personal electronic device enters the secondary alert radius 318 after an alert has been initiated, an alert is pushed to that particular personal electronic device and then monitored for the duration of the alert while residing within the secondary alert radius 318. The movement of the core alert radius 316 and the secondary alert radius 318 are determined based on the movement of the personal electronic device that initiated the alert.

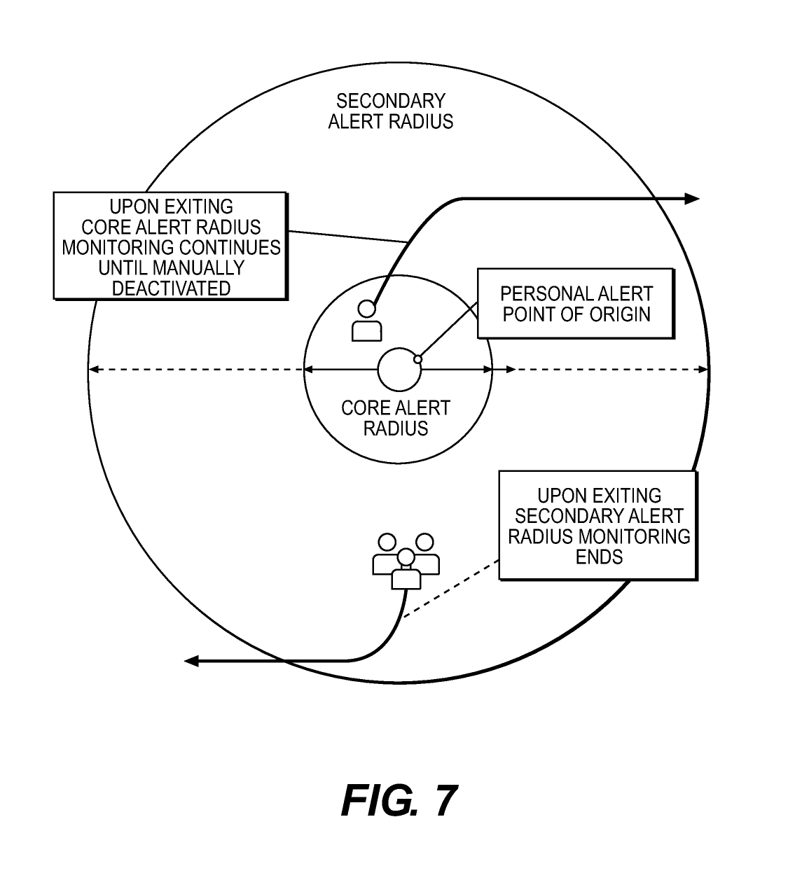

As illustrated in FIG. 7, as the personal electronic device initiating the alert moves, so does the core alert radius 316 along with the secondary alert radius 318. The measured distance from the point of origin of the personal alert to the outer edge of the core alert radius 316 and to the outer edge of the secondary alert radius are determined dynamically based on the particular programming.

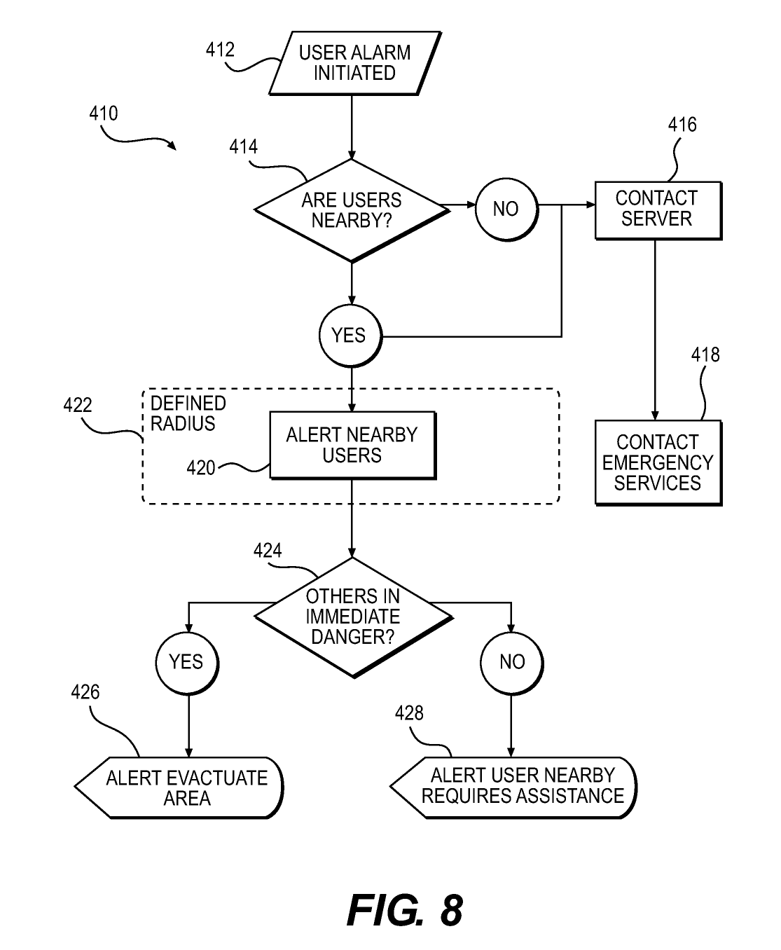

A flow chart diagram 410 illustrating the operation of the emergency alert communication system is illustrated in FIG. 8.

The sequence begins with the User Alarm Initiated (Step 412). After the alarm is initiated, a Yes or No decision Are Users Nearby? is made (Decision 414). If No, then Contact Server (Step 416) and then Contact Emergency Services (Step 418) occur. If Yes, then Alert Nearby Users (Step 420) occurs within a Defined Radius (Parameter 422).

After Alert Nearby Users (Step 420), then decision Others In Immediate Danger? is made (Decision 424). If Yes, then Alert Evacuate Area (Step 426). If No, then Alert User Nearby Requires Assistance (Step 428).

### Determination of Proximity

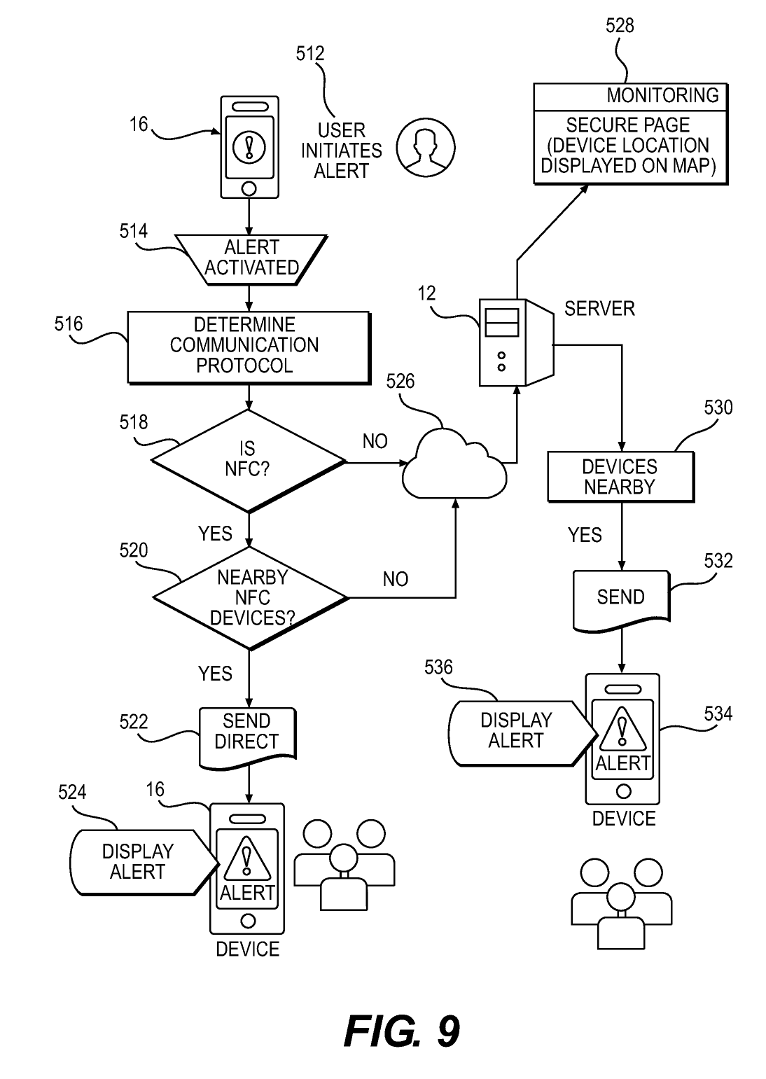

A flow chart 510 for determination of proximity of devices to a device initiated alert is illustrated in FIG. 9.

The User Initiates Alert (Step 512) using the personal electronic device 16 resulting in An Alert Activated (Step 514) followed by Determine Communication Protocol (Step 516). Then Is NFC? (i.e. is Near Field Communication Available?) (Decision 518).

If Yes for Decision 518, then Nearby NFC Devices? (i.e. are there any Near Field Communication Devices Available?) (Decision 520). If Yes for Decision 520, then Send Direct (i.e. send by NFC communication) (Step 522) to personal electronic device 16 to then Display Alert (Step 524).

If No for Decision 518, then the Alert Activated (Step 514) is communicated thru the Cloud 526 to the Server 12. The location information of the personal electronic device 16 is sent to Monitoring 528 to display the person device 16 location displayed on a map.

The Server 12 determines whether there are Devices Nearby? (i.e. are there Other Personal electronic devices 534 nearby or in proximity to the Device 16?) (Decision 530). If Yes, then Send (Step 532) an alert to the other devices 534 to Display Alert (Step 536).

### Determination for Alert Recipients

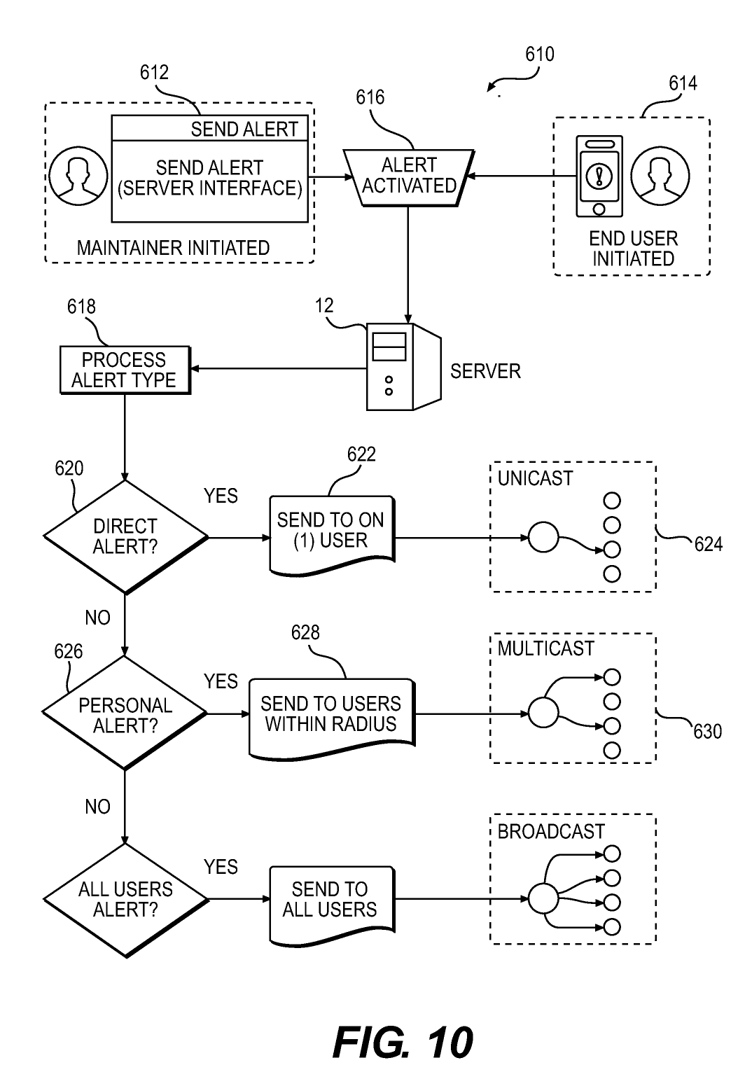

A flow chart 610 for determination for alert recipients is illustrated in FIG. 10.

In the event of a Send Alert (Step 612) thru the Server Interface, or End User Initiated (i.e. an End User Initiated alert) (Step 614), then the Alert Activated (Step 616) occurs, which is communicated to the Server 12 to Process Alert Type (Step 618).

After processing the alert type, then Direct Alert? (Decision 620). If Yes, then Send To One (1) User (Step 622) via Unicast (i.e. Unicast transmission) (Step 624). If No, then Personal Alert? (Decision 626). If Yes, then Send To Users Within Radius (Step 628) via Mulitcast (Step 630). If No, then All Users Alert? (Decision 632). If Yes, then Send To All Users (Step 634) and then Broadcast (Step 636).

It will be readily understood that the components of the present invention, as generally described and illustrated in the Figures herein, can be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

### Alert Initiation Parameters

An alert initiation by a person or user can be accomplished in various ways. The following list includes, but is not limited, to the various ways the alert is/can be activated in conjunction with the application and Server User Interface.

1. Manually
a. Press icon/link/button within the mobile application;
b. Use a gesture such as a swipe within the mobile application;
c. Press icon/link/button from Web Browser (Web App Version);
d. Initiated via the Main Server Control UI (User interface);
e. Long press/hold of mobile device physical button(s);
   i. Home;
   ii. Volume Up;
   iii. Volume Down; and
   iv. Combination of multiple.
f. Physical movement of device
   i. Shaking;
   ii. Drastic change in elevation (drop);
   iii. Combination of physical gestures;
      Example, Move device left to right then shake

2. Automatic
a. See Physical movement, above,
b. Alert(s) initiated within predetermined radius;
c. Alert(s) initiated from:
   i. Emergency Tower;
   ii. Call Box;
   iii. Pedestal; and
   iv. Other Alerting apparatus.
d. Audio Detection (not limited to):
   i. Gunshot;
   ii. Glass Breaking;
   iii. Vocal inflection; and
      Example, Drastic alteration in pitch or tone
   iv. Other predetermined sound parameters.
e. Proximity to potential threat (user)
   i. Initiated from main UI
f. Proximity to natural threat
   i. Initiated from CAP message; and
   ii. Initiated from Server UI.
g. Proximity to man-made threat
   i. Initiated from CAP message; and
   ii. Initiated from Server UI.
h. Proximity to other user(s)
i. Enter or Leave predetermined area radius
   i. Geo-Fence
j. Time-based
   i. User in geo-fenced area in excess of allowed time
k. Restricted Area
   i. User(s) and Server UI alerted when entering/exit
l. Proximity to BLE (Bluetooth Low Energy) Device(s)
   i. Ex. Tags, iBeacon(s), etc.

3. From 3^{rd} Party Application via ValcomLocate API
a. Ex. From eLaunch, BlackBoard, etc.

4. Any variation or combination of the above can be used to initiate alerts to the end users. The actual values (distance, range, and time of day) can be set/customized per location(s).

### Installation

The requirements for a stand-alone server: hardware, operating system, and Utilities, include:

### Hardware

A 1.0 Ghz processor or higher
512 mb RAM or higher
1 Gig Storage Space (150 mb is used for application)
10/100 LAN (Ethernet or Wi-Fi)

### Operating System

Windows Server 2003 (or higher)

OSX Server 10.6 (or higher)

Linux Server (any distribution)

### Utilities

Web Server (any)

Internet Access

Generic Instructions for Server Setup—What Functionality must be Available from the Server

1. Install software using Server Application installer.

2. Follow the prompts from installer.

3. Requires Internet Access.

4. Requires Local LAN Access.

### Specific Instructions for Installing Valcom Code on Server (Stand-Alone or Shared)

There are no specific instructions for installer the Server Application on a stand-alone or shared server other than using the operating system specific installer.

### Installing the App on Phones

Application can be installed via the device's specific “store” or via connect to link on server.

1. iOS Device—iTunes App Store

2. Windows Device—Widows App Store

3. Android Device—Google App Store

4. Fire Device—Amazon App Store

### Running the App as a Service

Application runs automatically using device operating system specific controls

### Updating the App

Application is updated automatically via the device's “app store” (see above).

### Removing the App

Application is removed using method specific to device's operating system.

Communications—Very Specifically, What Communications Types/Protocols are used for Determining Location

See Above

### Fine-Tuning Location

See Above

Phone to/from Server

See Above

### When Alert on Phone is Pressed

See Above

### Architecture

### General

The emergency alert notification system is a collection of modules, each able to perform a specific task related to delivering timely and relevant information to people, based on their absolute location, or their location relative to the location of an incident or event.

### Basic Functionality

1) Being able to get information to users, based on their location, effectively instantaneously;
2) User reads and acknowledge receipt of the information; and
3) Server is able to determine an individual's location within a very small margin of error, whether outdoors, or within a large, multistory building.

### Server

1) Server modules necessary to provide the functionality requested by the customer can be activated via new serial code or by separate plug-in download (I envision our own “app store” giving customers access to 3^{rd} party plug-ins or features that are not directly created by us. For example the ability to connect to 3^{rd} party authentication system like Blackboard); and
2) Active features are determined by the server, and could be made available via Valcom, Inc.

### Client

1) Based on device the client application will be available to the end-users via their devices app store as a free download;
2) Client abilities are universal across all devices and app stores, and all client downloads contain all possible client functionality;
3) All participating users must install the program; and
4) Upon install, the application runs in the background without visibility to the user, end-user interaction is only available when alert (message) becomes active either via the server or personal alert.

### Alerts

1) The system can push custom alert information to a mixed group of devices (see Compatibility).
2) A “group” may be any size, from 1 to SystemMax(?) System Max really based on Server Hardware. No current limitations.
3) Device independence is achieved by including any specific controls needed for the target platform when compiling the application for a specific device.

### Personal Help Button

1) Installed on each device as part of the Alert program;
2) Enables the user to initiate a request for help from anywhere;
3) Allows the server to immediately know the exact location of the help request;
4) Tracking also begins immediately upon alert activation;
5) Passive tracking is used (latitude and longitude sent when user moves X+ from starting location); and
6) Location movement is handled by device. Relayed to server only when required.

### Platform

### Compatibility

### Server

Windows is neither required nor used. The server can run on Linux (Ubuntu 12.04 LST), and can be ported to any Server OS (Windows, Linux, or OSX Server).

### Client

The client program can run on most current devices and operating systems, including:
1) PC Desktop/Laptop computers (2014, Vista, Windows 7, Windows 8.1) (Microsoft will no longer support XP after April 8^{th});
2) Microsoft Surface RS/Pro (Windows 8.1 or above);
3) 3^{rd} Party Windows Tablets (Windows 8.1 or above);
4) Windows Phone (Windows 8 Mobile or above);
5) Apple Desktop/Laptops (OSX 10.7 or above);
6) Apple iPhone (iOS 7.0 or above);
7) Apple iPad (iOS 7.0 or above);
8) Android Phone (4.3 or above);
9) Android Tablet (4.3 or above); and
10) Linux Desktops/Laptops (Ubuntu 10.04 and above recommended).

### Interoperability

The system can be “totally” flexible. Via API, the system can be extended to send data or commands, or receive data or commands, to/from almost any other equipment. This could include, but not be limited, to 3^{rd} Party Authentication systems, RFID monitoring systems or various information providers.

The system can monitor external equipment (e.g. Valcom, Inc. equipment, or other suitable equipment), filter the information, and determine if it should:

1) Automatically do something;

2) Automatically notify someone; and

3) No action required—continue monitoring.

### Valcom VE602× Products

The system can be designed or configured to interact with Valcom, Inc. servers. Further, the system can interact with fixed communication devices (non-smart), including:

1) Loudspeakers; and

2) LED signs.

### User Interface

### Management Graphic User Interface (GUI)

The system can comprise a management Graphic User Interface (GUI) that can provide the setup, options, and interface required for users to utilize their installed features.

### Client Graphic User Interface (GUI)

The system can comprise a client Graphic User Interface (GUI) that can provide, when an alert is received on a device, the following:

1) Alert text pops up on screen;

2) Alert tone activated; and

3) If silenced device is vibrated. This also can occur in addition to the Tone.

The system can be configured or designed so that, when the user presses the Acknowledge button, the following occurs:
1) Audible alert turns off; and
2) User Acknowledgment is relayed to server. Note: can include time user received alert, time user acknowledged alert, immediate location (latitude/longitude) initiate tracking (personal alert).

The system can be configured or designed so that, when the user closes the alert window, the following occurs:
1) Alert screen is minimized; and
2) Note: Closing the Alert Screen does not end the program, but just closes the pop-up screen. Additional alerts will still be received.

### Options:

The system can comprise the following options:
1) Pop up window vs full screen;
2) Do not lock up machine vs lock up the machine; and
3) Optional features can be either active or non-active based on administrator's choice.

### Alert Notification “Pop-Up” Software

### Server Software

Server to destination device
1) The communication is the same regardless of server platform or destination device type, making the system universal;
2) The method of sending alerts to multiple devices based on direct radius distance from initial start location;
3) The method can also be dynamic, based on number of people near the event, crowd density, type of alert, potential danger, or any number of other conditions;
4) The messages may be sent directly to the originator of the alert. At the same time a different message could go to the inner radius group, and yet a 3^{rd} message to the outer radius group;
5) Using whatever resources are required (browser capabilities, Valcom, Inc. plug-ins, Google, . . . ) translate messages to the originator to a pre-determined primary language; and
6) Audio to/from phone, TTS, STT.

### Client Software

1) The client program is required. That is how the server receives its location information and the users receive the alerts.
2) Depending on device and location infrastructure, a “silent” install can be provided.
3) The Client Application is “Silent” by default (no direct interaction from end-user until required (i.e. running invisible—meaning it appears to be a device system function may be possible for some devices).
4) With no user, will be able to run as a service and provide audible alert (no visual); and
5) When a user is logged-in, he will be made aware of an alert via pop-up and loud audible alert.

### Static, Dynamic, Precision, Zone, and Special Case Alerts

### Static Alerts

An alert can be broadcast as a facility-wide call, with everyone who is within range of the destination devices (loudspeakers, LED signs, . . . ) receiving the same message.

The alert can also be directed somewhat more specifically, such as to, “North Campus” or “Johnson Hall”.

### The Real-Time Capabilities of a Dynamic Alert:

With Dynamic alerts, the groups do not need to be defined ahead of time. Further, there is no need to go to a larger group, combine groups, nor disturb everyone with all a call when the desired destinations don't match the predefined ones. With this system, the destination is simply clicked on, and the particular radius is then clicked on to send the alert.

### Precision Alerts:

Alerts can be sent to any or all people within a defined area or location. Different messages can be precisely delivered to the individuals or users who need the information. For example, the Personal Assistance Button is pressed on a phone by a user at location “M”. A general Warning message is immediately sent to everyone within 100 feet of location “M”. For example, then a request for assistance is sent to the closest people (e.g. closest six (6) people relative to location “M”). Situation updates are sent to the originator of the alarm.

### Zone Alerts:

A zone is a defined location or area of interest. Among other uses, a zone can keep a record of who enters and leaves the zone. For example, if an employer want to know how much time John Doe spends smoking, or if the employer wants to receive a notification when John Doe arrives at or leaves work, this information can be available with the system.

### Special Case Alerts:

For example, these functions can have the capability of taking over or bringing down an entire network depending on the situation and threat level.

### Windows Clients Only

Windows requires written request and indemnification on file from the owner of system. Possible options include taking over the entire screen, or locking up machines for a designated length of time.

### Typical System Operation

The system can immediately locate and identify people in an area, or in the vicinity of an area, event, or incident. All “Automatic” functions below can have setup options for automatic and/or manual initiation.

The system can be designed or configured to provide Automatic creation and launch of CAP-based alert, based on the following:

1) The location of the help request; and

2) The vicinity (radius around) of help request.

The system can be designed or configured to provide Automatic simultaneous broadcast of the alert to the following:
1) Smart phones;
2) Portable smart devices;
3) Fixed (desktop) devices;
4) Loudspeakers;
5) LED signs; and
6) Various and custom customer provided communications and end-point equipment.

### Automatic Notification of Security

### Automatic 911

The system can be designed or configured to Automatically initiates Real-Time Location and Tracking functions to provide the following:

1) can provides authorities with critical real-time information during the Crisis;

2) can provide information during Crisis Handling Evaluation; and

3) can provide evidence for prosecution.

The system can be designed or configured to Immediately provides authorities with the following:

1) possible witness(es);

2) possible perpetrator(s);

3) Current Location, Direction of movement, Tracking, of people in the area; and

4) Event Logging

### Summary of Location, Tracking, and Alert Capabilities

The system can provide various ways information can be handled, including:
1) an emergency alarm is activated;
2) the location of the emergency is immediately known and provided to Security via their smart phones, wherever they are positioned at the facility at the time of the event or incident;
3) information is obtained about people in the area, such as how many people, exactly where they are located, speed, and direction of movement. Authorities are provided with information on possible witnesses, possible perpetrator(s);
4) an alert can be sent to the individuals or users closest to the emergency location, notifying them of an immediate potential for danger. The term “closest” is very flexible. At the time of the initial alert it could mean anyone within 100 feet of the location of the event or incident. As things develop it could refer to the six (6) people closest to the originator of the emergency event (even if the originator has changed location). Later it could show (for example) the three (3) people who were nearby, and who went the opposite direction;
5) the individuals or users near the incident or event can also be told a person may be in need of assistance at such and such location;
6) authorities can keep track of the location of the originator of the alarm, who often keeps moving;
7) authorities can see who moves toward the victim (help) and away (self-protection, possible perpetrator);
8) a situation like this rarely plays out in one location. Dynamic tracking and alerting provide a new level of information; and
9) the location of a situation may change as events progress, requiring new or updated alerts to various participants.

### Additional Features

The system can be designed or configured to provide the following:

1) 2-way keyboard based communications;

2) Text to Speech communication;

3) Speech to Text communication; and

4) Two-way Voice communications.

### Products

eHelp

The system can be designed or configured to provide the following features:

1) Student emergency call button;

2) Secure;

3) Includes GIS info;

4) Initiate calls—one to many;

5) Answered call plays out to one or more other points;

6) All activity date/time stamp—data and audio logged/recorded;

7) Easy access to duress button—logo driven;

8) Activate lights/camera at our closest emergency telephones;

9) Notify others within given distance of the event;

10) Track phone movement after call initiated;

11) Record and track others within “x” distance of event; and

12) PC tool bar help icon.

eLaunch

The system can be designed or configured to provide the following features:

1) Limited message; and

2) Secure.

eLocate

The system can be designed or configured to provide the following features:

1) Designate points (LAT/LON) with tags back to database;

2) Track movement of vehicles, etc.; and

3) Barcode reader passes Mac address and LAT/LON.

eNotification

The system can be designed or configured to provide the following features:

1) Replaces SMS—Provides “Screen Pop”;

2) Drive prioritized message to device; and

3) Record acknowledge;

4) No user sign-up required;

5) “Instant view” at prioritized level;

6) After acknowledge—Visual notification remains;

7) With adjustable time-0ut;

8) Can be GEO targeted;

9) School Logo;

10) Auto purge option;

11) Secure; and

12) Silent loopback to ensure operation.

1. An emergency alert notification method, comprising:
initiating an alert using a personal electronic device by a user;
sending the alert to a server; and
sending the alert from the server to other users located nearby the user.

2. The method according to claim 1, wherein the other users are alerted via other personal electronic devices of the other users.

3. The method according to claim 1, including sending the alert to NearField devices.

4. The method according to claim 2, including sending the alert to NearField devices.

5. The method according to claim 1, including recording ambient noise using the personal electronic device of the user.

6. The method according to claim 2, including recording ambient noise using the personal electronic device of the user.

7. The method according to claim 3, including recording ambient noise using the personal electronic device of the user.

8. The method according to claim 4, including recording ambient noise using the personal electronic device of the user.

9. The method according to claim 1, including analyzing the ambient noise.

10. The method according to claim 3, including analyzing the ambient noise.

11. The method according to claim 1, including the server contacting emergency services.

12. The method according to claim 1, including tracking movement of the user.

13. The method according to claim 1, including tracking movement of one or more of the other users.

14. The method according to claim 1, generating a defined alert notification radius based on a location of the user.

15. The method according to claim 1, including determining the geolocation of the user.

16. The method according to claim 1, including determining a communication protocol after the alert is activated.

17. The method according to claim 16, determining whether NearField Communication capabilities and one or more NearField Communication devices are nearby the user, and if so then sending a direct alert to the one or more personal electronic devices of one or more of the nearby other users.

18. The method according to claim 16, determining whether NearField Communication capabilities and one or more NearField Communication devices are nearby the user, and if not then communication thru the Cloud to a Server, and then sending the alert to the other users via their personal electronic devices.

19. The method according to claim 1, wherein the alert is displayed on one or more of the personal electronic devices of the other users.

20. The method according to claim 1, including the server determining the alert type.

21. The method according to claim 20, including communicating a direct alert to one or more users via Unicast.

22. The method according to claim 20, including communicating a personal alert to other users via Multicast.

23. The method according to claim 20, including communicating the alert to all users via Broadcast.

24. The method according to claim 1, wherein the alert is sent at least partially wirelessly to a server; and wherein the alert is sent at least partially wirelessly from the server to other users located nearby the user.

25. The method according to claim 1, including locating the user initiating the alert, and wherein the alert is sent at least partially wirelessly and through a network to a server; and wherein the alert is sent from the server through a network and at least partially wirelessly to other users located nearby the user.

26. An emergency alert notification system, comprising:
a first user electronic device for initiating an alert;
a second user electronic device in proximity of the first user electronic device for receiving the alert; and
a communication system for sending the alert from the first user device to the second user device.

27. The system according to claim 26, wherein the communication system comprises a Local Area Network (LAN).

28. The system according to claim 26, wherein the communication system comprises a cellular network.

29. The system according to claim 26, wherein the communication system comprises radio wave transmission.

30. The system according to claim 26, wherein the communication system comprises a server.

31. The system according to claim 30, wherein the server processes the alert type.

32. The system according to claim 30, wherein the alert type is at least one selected from the group consisting of Unicast, Multicast, and Broadcast.

33. The system according to claim 26, wherein the system can record the ambient noise around the first user device.

34. The system according to claim 26, wherein the system can track movement of the first user device.

35. The system according to claim 34, wherein the system can track movement of the second user device.

36. A user device for use in the system according to claim 26.

37. An emergency alert notification method, comprising:
initiating an alert for an emergency situation or event occurring at a particular location; and
a user or person in proximity to the location of the emergency situation or event receiving the alert.

38. The method according to claim 37, wherein the alert is manually activated by the user or person or another user or person in proximity to the location of the emergency situation or event.

39. The method according to claim 37, wherein the alert is automatically activated by configuration or software of an alert notification device or system.

40. The method according to claim 38, wherein the alert is automatically activated by configuration or software of an alert notification device or system.
